(19) United States
(12) Patent Application Publication
(10) Pub. No.: US 2024/0300136 A1
(43) Pub. Date: Sep. 12, 2024

(54) SHEET MATERIAL PROCESSING TOOL, SHEET MATERIAL PROCESSING STATION, AND SHEET MATERIAL PROCESSING MACHINE

(71) Applicant: BOBST MEX SA, Mex (CH)

(72) Inventors: Arnaud DEKERVEL, Thonon-les-bains (FR); Patrice CHATRY, Lugrin (FR)

(73) Assignee: BOBST MEX SA, Mex (CH)

(21) Appl. No.: 18/262,600

(22) PCT Filed: Jan. 25, 2022
(86) PCT No.: PCT/EP2022/051531

§ 371 Date: Jul. 24, 2023

(30) Foreign Application Priority Data
Feb. 1, 2021 (EP) 21154552.0

(51) Int. Cl. B26D 7/26; B26D 1/06; B26D 7/01

(52) U.S. Cl. CPC B26D 7/2614; B26D 1/065; B26D 7/015

(57) ABSTRACT

A sheet material processing tool (14), especially a cardboard or paper processing tool, is described. It comprises a carrier frame (26), having a front frame member (28) extending substantially perpendicular to a processing direction (P) for a sheet material to be processed, a rear frame member (30) extending substantially parallel to the front frame member (28), a first lateral frame member (32) connecting corresponding first ends (28a, 30a) of the front frame member (28) and the rear frame member (30) and a second lateral frame member (34) connecting corresponding second ends (28b, 30b) of the front frame member (28) and the rear frame member (30). Furthermore, a first multi-purpose interface (54) is provided for selectively connecting a first tool element for processing the sheet material to the carrier frame (26). Additionally, a sheet material processing station is presented. It comprises a support structure, wherein a sheet material processing tool(14) is connected to the support structure. Moreover, a sheet material processing machine having such a sheet material processing station is explained.

The invention is directed to a sheet material processing tool, especially a cardboard or paper processing tool. The sheet material processing tool comprises a carrier frame, having a front frame member extending substantially perpendicular to a processing direction for a sheet material to be processed, a rear frame member extending substantially parallel to the front frame member and substantially perpendicular to the processing direction, a first lateral frame member connecting corresponding first ends of the front frame member and the rear frame member and a second lateral frame member connecting corresponding second ends of the front frame member and the rear frame member, wherein the second ends and the first ends are arranged opposite each other.

The invention further relates to a sheet material processing station comprising a support structure, wherein such a sheet material processing tool is connected to the support structure.

Additionally, the invention is directed to a sheet material processing machine, especially a sheet material cutting machine, comprising such a sheet material processing station.

Sheet material processing tools having the above-described configuration are known in the art. The same is true for sheet material processing stations comprising such tools and corresponding sheet material processing machines.

Known tools may for example be configured as so-called blanking tools, i.e. tools being configured for separating actually desired portions of a sheet material, which are called layout, from remaining portions thereof which are strictly speaking not part of the product to be produced from the sheet material. The latter portions may be designated as waste portions.

Alternatively, known tools may be so-called full-sheet tools, i.e. tools being configured for cutting off a front portion of a sheet material, wherein the remaining portion comprises both the desired portions, i.e. the layout, and the remaining portions surrounding the layout. In this case, the layout will be separated from the remaining portions in a further process step.

The sheet material may have the form of a continuous web or a discrete, i.e. discontinuous, sheet.

Examples of sheet materials are paper, cardboard or polymers.

Since known tools are specifically designed for performing the corresponding task or operation, they are able to do so in an efficient manner.

Furthermore, it is know that different sheet material processing jobs need different tools and/or differing arrangements of tools within the corresponding sheet material processing station or sheet material processing machine.

As a consequence thereof, frequent job changes lead to comparatively high efforts concerning the reconfiguration of the sheet material processing stations and sheet material processing machines used for performing the job.

For these reasons, the problem to be solved by the present invention is to reduce the efforts for reconfiguring sheet material processing stations and sheet material processing machines in the context of a job change.

The problem is solved by a sheet material processing tool of the type mentioned above, comprising a first multi-purpose interface for selectively connecting a first tool element for processing the sheet material to the carrier frame. Thus, the sheet material processing tool may be equipped with different first tool elements, which all may be connected to the carrier frame via the first multi-purpose interface. Consequently, the sheet material processing tool can be easily and quickly reconfigured for performing different tasks or jobs. The effort for performing such a reconfiguration is very low since only the first tool element needs to be exchanged, i.e. the remaining parts stay the same. Such a sheet material processing tool can also be described as being very flexible or modular. In this context, the multi-purpose interface is to be understood as an interface by which different first tool elements may be connected to the carrier frame. In other words, the multi-purpose interface disposes of a certain universality. As a consequence thereof, interfaces of known tools which are specifically adapted for the connection of two specific parts of the tool are not multi-purpose interfaces.

The carrier frame of the sheet material processing tool according to the invention may be designated a tool base or base tool since different first tool elements may be mounted thereon.

In this context, the first tool elements may also be designated an add-ons or tool extensions.

According to an embodiment, the sheet material processing tool comprises a rear wall extending substantially parallel to the rear frame member, a first side wall extending substantially parallel to the first lateral frame member, and a second side wall extending substantially parallel to the second lateral frame member. The front frame member, the rear wall, the first side wall and the second side wall delimit a duct through which a sheet or portions of a sheet may pass. In this context the walls are to be understood as parts being separate from the frame members. The duct is additionally configured such that the sheet or portions thereof pass therethrough after they have been processed by the sheet material processing tool. In other words, a final or intermediate product is directed through the duct, whereas potentially remaining portions of the sheet, e.g. waste portions, may be withdrawn from the sheet material processing tool along a different path. Such a sheet material processing tool is compact. The clear separation of paths for products or intermediate products and waste additionally leads to the fact that the tool is adapted for operating at elevated speed.

At least one of the rear wall, the first side wall and the second side wall may be movably supported within the carrier frame such that a size of the duct is adjustable. Consequently, the duct can be adapted to different sizes of the product or intermediate product to be passed therethrough. Thus, the product or intermediate product may be precisely guided on its way through the duct. This leads to the possibility of precisely positioning the product or intermediate product when exiting the duct.

Preferably, at least one of the rear wall, the first side wall and the second side wall is coupled to a respective drive unit such that the at least one of the rear wall, the first side wall and the second side wall is adjustable within the carrier frame in a motorized manner. In other words, a size of the duct formed by the walls can be adjusted automatically. As a consequence thereof, the duct may be adjusted precisely and quickly.

In a variant, a flexible cover is attached to the rear wall and/or the rear frame member such that a spacing between the rear wall and the rear frame member is covered. The flexible cover prevents any sort of interference of the spacing or elements being present in the spacing and a sheet material to be processed. Consequently, the sheet material processing tool can operate in a reliable manner. Since the cover is flexible, its functionality is independent from the size of the spacing i.e. a distance of the rear wall from the rear frame member which may vary.

Additionally, a second multi-purpose interface may be provided for selectively connecting a second tool element for processing the sheet material to the carrier frame. The sheet material processing tool may consequently be equipped with different second tool elements, which are connected to the carrier frame via the second multi-purpose interface. In doing so, the sheet material processing tool can be quickly and easily reconfigured for performing different tasks or jobs. The effort for performing such a configuration or reconfiguration is very low since only the second tool element needs to be exchanged, i.e. the remaining parts of the sheet material processing tool stay the same. The sheet material processing tool is also flexible or modular with respect to the second multi-purpose interface. Again, the multi-purpose interface is to be understood as an interface by which different second tool elements may be connected to the carrier frame. In other words, the multi-purpose interface disposes of a certain universality. As a consequence thereof, interfaces of known tools which are specifically adapted for the connection of two specific parts of the tool are not multi-purpose interfaces.

In accordance with the first tool elements, also the second tool elements may be designated an add-ons or tool extension.

The second multi-purpose interface may be arranged on the rear wall. Thus, the second tool element may be mounted in a stable and reliable manner. In case the rear wall is movable, also the second multi-purpose interface is movable.

The first multi-purpose interface may be provided on the front frame member. Thus, the first tool element may be mounted on the frame member in a stable and reliable manner.

In an alternative, the first tool element is a cutting member for cutting a sheet to be processed, wherein the first tool element is connected to the carrier frame via the first multi-purpose interface. For example, the cutting member may be used to cut-off a front portion of a sheet which is held by a gripper bar.

Alternatively or additionally, the second tool element is a sheet support member for supporting and/or guiding a sheet to be processed, wherein the second tool element is connected to the carrier frame via the second multi-purpose interface.

A tool comprising a first tool element being a cutting member and a second tool element being a sheet support member may be designated a full-sheet tool. Such a tool is adapted for cutting off a front portion of a sheet, wherein the remaining portions comprise both layout portions and waste portions. The layout portions will be separated from the waste portions in a subsequent process step.

In a further alternative, the first tool element and the second tool element are comprised by a blanking assembly, wherein the blanking assembly is connected to the carrier frame via the first multi-purpose interface and the second multi-purpose interface. Consequently, the sheet material processing tool is a blanking tool. In this context, the side walls and the rear wall may be in a specific, e.g. retracted, position in order to provide the necessary space for the blanking assembly.

The blanking assembly may comprise at least one separation bar separating a processing plane of the blanking assembly in at least two sections each corresponding to a blank to be removed from a sheet to be processed. Consequently, the blanking assembly is adapted for processing sheets comprising more than one layout.

A tool comprising a first tool element and a second tool element being comprised by a blanking assembly may be designated a blanking tool.

Consequently, the sheet material processing tool according to the invention may also be called a combined full-sheet and blanking tool.

Moreover, the sheet material processing tool according to the invention, the cutting member, the sheet support member and the blanking assembly form a kit which may be used to generate different tools, e.g. a blanking tool and a full-sheet tool.

The problem is additionally solved by a sheet material processing station of the type mentioned above, wherein a sheet material processing tool according to the invention is connected to the support structure. Such a sheet material processing station can be easily and quickly reconfigured to specific processing steps with a very low effort.

The sheet material processing station may also comprise a further tool and the sheet material processing tool may be arranged within the support structure such that it is able to interact with the further tool in order to process sheets. In this context the sheet material processing tool may be a lower tool and the further tool may be an upper tool interacting therewith.

Moreover, the sheet material processing station may have a sheet pile support unit being provided below the sheet material processing tool. The sheet pile support unit is adapted for receiving and supporting sheets which have been passed through the duct of the sheet material processing tool.

According to an embodiment, the sheet material processing tool is supported in the support structure via at least one linear bearing means such that the sheet material processing tool may selectively be arranged in an operational position, in which the sheet material processing tool is configured for at least contributing to the processing of sheet material, or in an extended position, in which the sheet material processing tool sticks out from the support structure. Preferably, a direction between the operational position and the extended position is transverse with respect to a processing direction, i.e. the sheet material processing tool may stick out at a side of the sheet material processing station. Thus, the sheet material processing station provides good access to the sheet material processing tool for its reconfiguration, i.e. for mounting or dismounting first and second tool elements. Using the linear bearing means the sheet material processing tool may be transferred from the operational position to the extended position in a drawer-like manner. The same applies to the transfer from the extended position to the operational position.

According to an embodiment, the sheet material processing station comprises at least one support arm which is configured for supporting the sheet material processing tool in its extended position. Optionally, the support arm is pivotably supported such that it can be moved to a retracted position when not in use. A corresponding pivotal axis may extend in a substantially vertical direction.

Beyond that, all effects and advantages which have been explained in connection with the sheet material processing tool also apply to the sheet material processing station and vice versa.

The problem is also solved by a sheet material processing machine of the type as mentioned above, comprising a sheet material processing station according to the invention. The sheet material processing machine is for example a die cutting machine. All effects and advantages which have been explained in connection with the sheet material processing tool or the sheet material processing station also apply to the sheet material processing machine and vice versa.

The invention will now be explained with reference to an embodiment which is shown in the attached drawings. In the drawings,

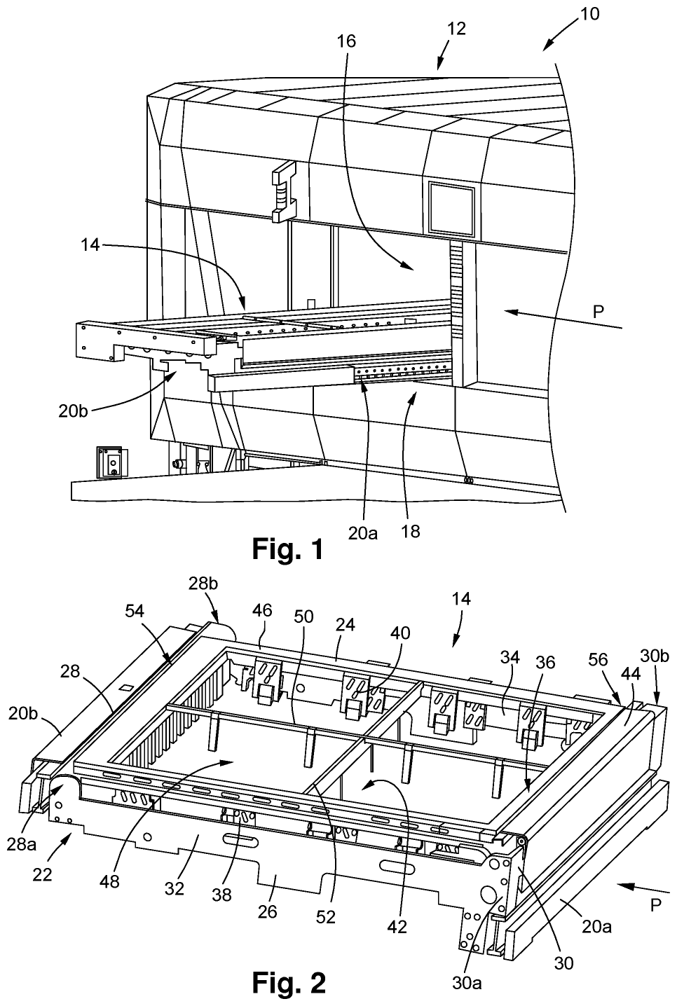

FIG. 1 shows a portion of a sheet material processing machine according to the invention having a sheet material processing station according to the invention with a sheet material processing tool according to the invention being configured as a blanking tool,

FIG. 2 shows the sheet material processing tool of FIG. 1 in a separate representation,

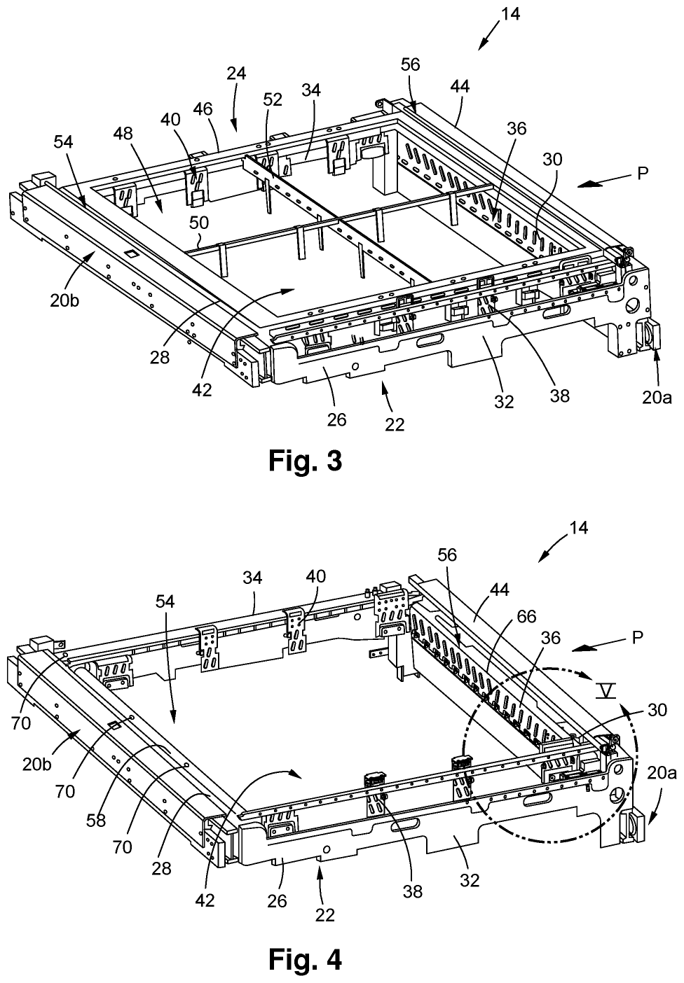

FIG. 3 shows the sheet material processing tool of FIG. 2 from a different perspective,

FIG. 4 shows the sheet material processing tool of FIG. 3, wherein a blanking assembly has been withdrawn,

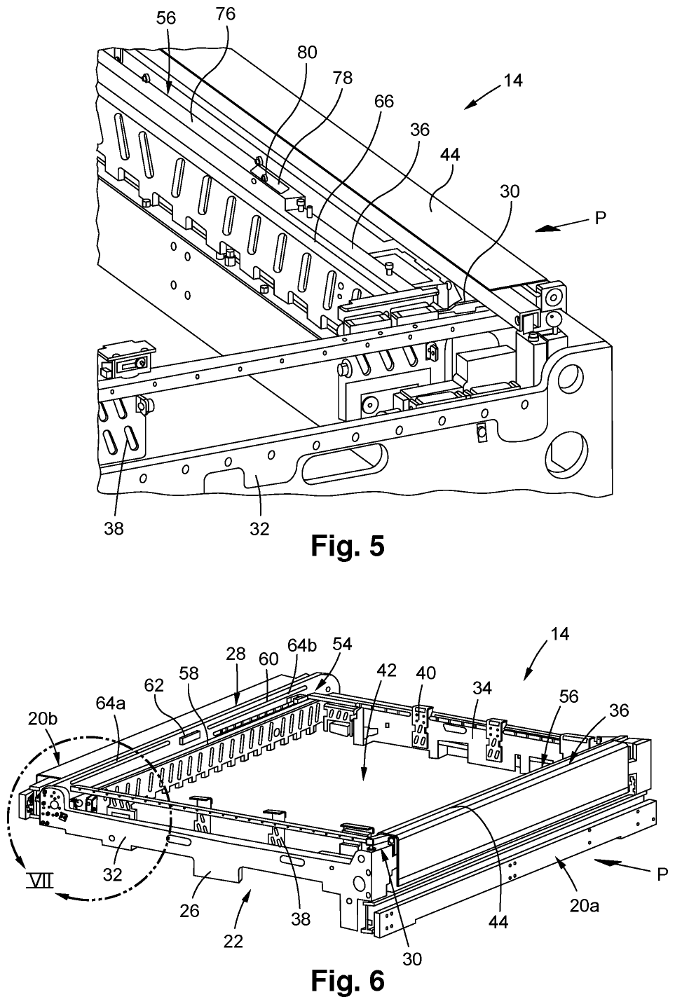

FIG. 5 shows a detail V of the sheet material processing tool of FIG. 4,

FIG. 6 shows the sheet material processing tool of FIGS. 2 and 3 from a further perspective,

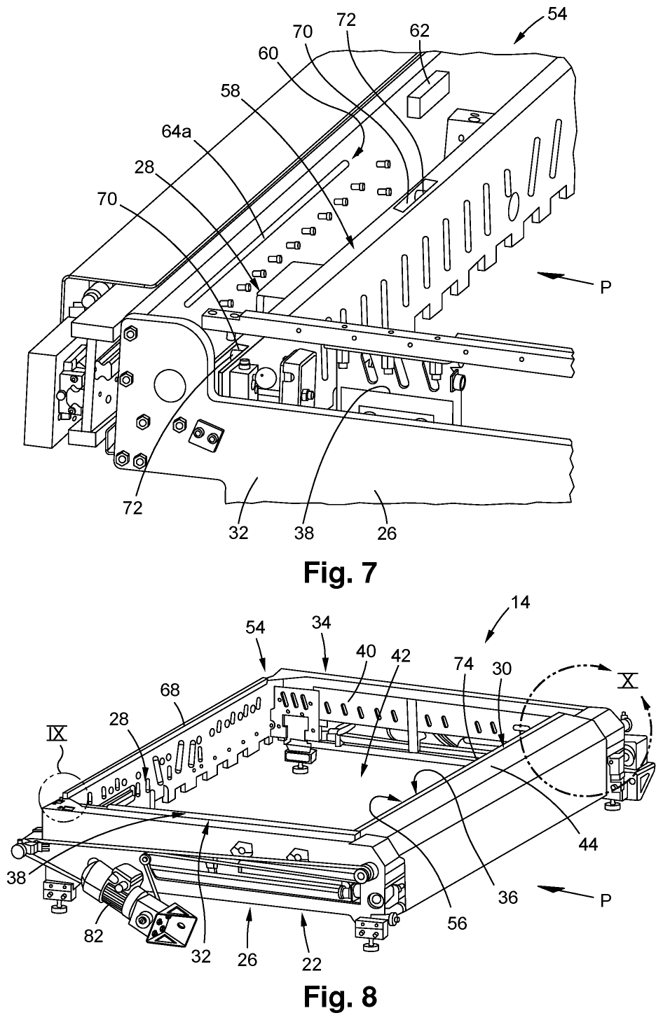

FIG. 7 shows a detail VII of the sheet material processing tool of FIG. 6,

FIG. 8 shows the sheet material processing tool according to the invention being configured as a full-sheet tool,

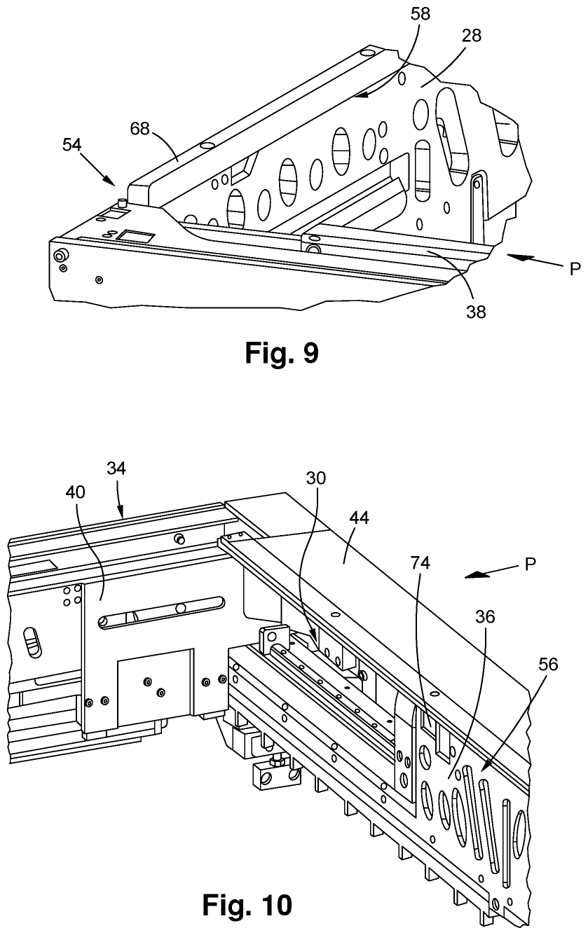

FIG. 9 shows a detail IX of the sheet material processing tool of FIG. 8,

FIG. 10 shows a detail X of the sheet material processing tool of FIG. 8, and

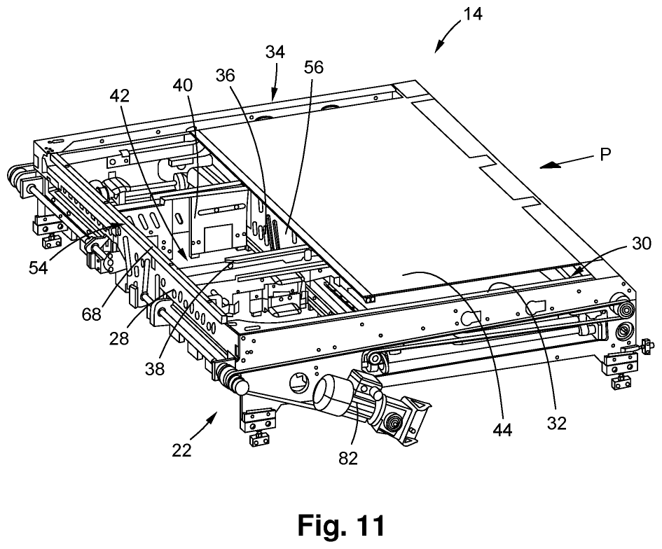

FIG. 11 shows the sheet material processing tool of FIG. 8, wherein it is adapted to a different size of sheets.

FIG. 1 shows a sheet material processing machine 10 which is a die cutting machine in the example shown. It is configured for processing cardboard.

The sheet material processing machine 10 comprises among others a sheet material processing station 12 which will be explained in more detail in the following.

Other sheet material processing stations of the sheet material processing machine 10 are for example a sheet material receiving station and a sheet material cutting station.

In the embodiment shown in FIG. 1 the sheet material processing station 12 is configures as a blanking station, i.e. a station in which the layout is separated from the sheet material and put on a stack.

To this end the sheet material processing station 12 comprises a sheet material processing tool 14 which, in the example shown, is configured as a blanking tool for cardboard.

More precisely, the sheet material processing tool 14 is configured as a lower tool and is configured for interacting with an upper tool 16 in a generally known manner.

The sheet material processing station 12 comprises a support structure 18.

The sheet material processing tool 14 is supported on the support structure 18 via two linear bearing means 20a, 20b.

Consequently, the sheet material processing tool 14 is slidably supported on the support structure 18 or within the sheet material processing station 12 in a drawer-like manner.

In this context, the sheet material processing tool 14 may selectively be arranged in an extended position which is represented in FIG. 1. In this position, the sheet material processing tool 14 laterally sticks out from the support structure 18.

Alternatively, the sheet material processing tool 14 may selectively be arranged in an operational position, in which the sheet material processing tool 14 is configured for at least contributing to the processing of sheet material. In this position, the sheet material processing tool 14 is arranged within the sheet material processing station 12 below the upper tool 16 such that the tools 14, 16 can interact.

With respect to a processing direction P of the sheet material processing machine 10, the sheet material processing tool 14 is slidable in a transverse direction.

The linear bearing means 20a is thus a rear bearing means with respect to the processing direction P and the linear bearing means 20b a front bearing means.

The sheet material processing tool 14 can be seen in more detail in FIG. 2, wherein also the linear bearing means 20a, 20b are represented even though they do not form part of the sheet material processing tool 14.

The sheet material processing tool is generally composed of a tool base 22 and a blanking assembly 24 connected thereto.

The tool base 22 comprises a carrier frame 26 having a front frame member 28 extending substantially perpendicular to the processing direction P and a rear frame member 30 extending substantially parallel to the front frame member 28 and substantially perpendicular to the processing direction P.

Furthermore, the carrier frame 26 comprises a first lateral frame member 32 connecting corresponding first ends 28a, 30a of the front frame member 28 and the rear frame member 30 and a second lateral frame member 34 connecting corresponding second ends 28b, 30b of the front frame member 28 and the rear frame member 30.

The second ends 28b, 30b and the first ends 28a, 30a are arranged opposite each other.

The sheet material processing tool 14 additionally comprises a rear wall 36 extending substantially parallel to the rear frame member 30, and being movably arranged on the carrier frame 26.

Moreover, the sheet material processing tool 14 has a first side wall 38 extending substantially parallel to the first lateral frame member 32 and being movably arranged on the carrier frame 26.

Furthermore, a second side wall 40 is provided extending substantially parallel to the second lateral frame member 34 and also being movably arranged on the carrier frame 26.

The front frame member 28, the rear wall 36, the first side wall 38 and the second side wall 40 delimit a duct 42 through which a sheet or portions of a sheet may pass.

Due to the fact that the rear wall 36, the first side wall 38 and the second side wall 40 are arranged movably on the carrier frame 26, a size of the duct 42 is adjustable.

Additionally, the rear wall 36, the first side wall 38 and the second side wall 40 are adjustable within the carrier frame 26 in a motorized manner.

To this end they are coupled to a respective drive unit which are not represented in FIGS. 1 to 7 and will be explained later.

The sheet material processing tool 14 also is equipped with a flexible cover 44 which is attached to the rear wall 36 and the rear frame member 30 such that a spacing between the rear wall 36 and the rear frame member 30 is covered.

The blanking assembly 24 is essentially composed of a blanking assembly frame 46 which defines a substantially rectangular opening 48.

Moreover, the blanking assembly 24 has two separating bars 50, 52 subdividing the opening 48 into four blanking portions.

The separating bar 50 substantially extends in a direction parallel to the processing direction P. It divides the opening 48 into two halves of substantially the same size.

The separating bar 52 is oriented substantially transverse to the processing direction P. It also divides the opening 48 into two halves of substantially the same size.

In doing so, a processing plane of the blanking assembly 24 is separated into four sections each corresponding to a blank to be removed from a sheet to be processed.

As is especially visible from a combination of FIGS. 3 and 4, the blanking assembly 24 is connected to the carrier frame 26 via a first multi-purpose interface 54 and a second multi-purpose interface 56.

Generally speaking, the first multi-purpose interface 54 is configured for selectively connecting a first tool element to the carrier frame 26.

The second multi-purpose interface 56 is configured for selectively connecting a second tool element to the carrier frame 26.

Consequently, in the example shown, the first tool element and the second tool element are comprised by the blanking assembly 24.

The first multi-purpose interface 54 is provided on the front frame member 28.

The second multi-purpose interface 56 is arranged on the rear wall 36.

In order to connect the blanking assembly 24 to the carrier frame 26 or tool base 22, the first multi-purpose interface 54 comprises a first support surface 58 on which a front portion of the blanking assembly frame 46 is supported in a vertical direction (see especially FIGS. 4, 6 and 7).

Moreover, an abutment surface 60 is provided as part of the first multi-purpose interface 54 against which the blanking assembly frame 46 abuts in a horizontal direction being oriented substantially in parallel to the processing direction P (see especially FIGS. 6 and 7).

Additionally, a centering protrusion 62 is provided in on the abutment surface 60 for centering the blanking assembly 24 along a direction transverse to the processing direction P (see especially FIGS. 6 and 7).

In the mounted state of the blanking assembly 24 the centering protrusion 62 engages into a centering recess provided on the blanking assembly 24, more precisely on the blanking assembly frame 46 (not shown).

Moreover, the first multi-purpose interface 54 comprises two openings 64a, 64b which are arranged on the abutment surface 60 (see especially FIGS. 6 and 7).

The openings 64a, 64b are configured for receiving corresponding mounting pins (not shown) extending from the blanking assembly frame 46 in a direction substantially parallel to the processing direction.

At its rear end, i.e. at the end of the blanking assembly frame 46 with respect to the processing direction P, a protrusion (not shown) substantially extending over the entire width of the blanking assembly frame 46 is provided.

This protrusion is received in a corresponding slot 66 of the second multi-purpose interface 56 (cf. FIGS. 4 and 5).

The slot 66 is located on the rear wall 36, wherein an opening of the slot 66 is substantially oriented in the processing direction P.

In the example shown, the protrusion on the blanking assembly frame 46 has a substantially wedge-shaped cross section. The same is true for the slot 66 into which the protrusion extends in the mounted state of the blanking assembly 24.

Thus, starting from a non-mounted state of the blanking assembly 24, the rear wall 36 needs to be moved into a positon sufficiently close to the rear frame member 30 or sufficiently spaced apart from the front frame member 28 such that the blanking assembly 24 can be inserted between the front frame member 28 and the rear wall 36 and the pins of the blanking assembly frame 46 can be inserted into the corresponding openings 64a, 64b.

Thereafter, the wedge-shaped protrusion is oriented such that it is positioned substantially in front of the slot 66. Then the rear wall 36 is moved towards the blanking assembly frame 46 such that the protrusion is engaged by the slot 66 and the pins are pushed into the corresponding openings 64a, 64b.

As a consequence thereof, the blanking assembly 24 is fixedly held on the carrier frame 26 or the tool base 22. Additionally, it is precisely positioned in the processing direction P by abutting against the abutment surface 60.

With respect to a transverse direction it is precisely positioned due to the engagement of the centering protrusion 62.

In a vertical direction the blanking assembly 24 is precisely positioned by abutting against the support surface 58.

Moreover, a sensor detecting a position of the rear wall 36 can be provided.

Using such a sensor the correct mounting of the blanking assembly 24 may be derived if a predefined position of the rear wall 36 is detected. The sensor may be a proximity sensor.

An alternative configuration of the sheet material processing tool 14 will be explained in connection with FIGS. 8 to 10.

In this alternative the sheet material processing tool 14 is configured as a so-called full-sheet tool. Within such a tool the layouts are left within the sheet material and portions of the sheet material with the layout are put on a stack below the duct 42 of the tool.

In its configuration as a full-sheet tool the sheet material processing tool 14 comprises a cutting member 68 being configured for cutting off a front portion of the sheet material, especially wherein the front portion is held by a gripper assembly for transporting the sheet material through the sheet material processing machine 10.

The cutting member 68 is connected to the carrier frame 46 via the first multi-purpose interface 54. Thus, the cutting member 68 is a first tool element.

In this context, the cutting member 68 abuts against the support surface 58 of the first multi-purpose interface 54.

Moreover, the first multi-purpose interface 54 comprises a plurality of openings 70 which are arranged in the support surface 58 (see especially FIGS. 4, 6 and 7).

Behind each of these openings 70 an engagement bolt 72 is provided. In the example shown the engagement bolts 72 substantially extend along the processing direction P (see especially FIG. 7).

On a side of the cutting member 68 which is a lower side in its mounted state, hooks (not shown) are provided which are configured to extend through a respective one of the openings 70 and engage the corresponding engagement bolt 72.

The hooks may be spring biased such that the cutting member 68 is securely held on the support surface 58 if the hooks engage the corresponding engagement bolts 72.

Alternatively or additionally, the surfaces of the hooks engaging the engagement bolts 72 may be sloped in order to achieve the same effect.

In the example shown four openings 70 with respective engagement bolts 72 are provided. Accordingly, the cutting member 68 comprises four hooks.

Furthermore, the first multi-purpose interface 54 comprises a securing means in the form of a pin (not shown) being supported on the front frame member 28 such that it protrudes from the support surface 58 in a spring biased manner.

On the cutting member 68 a corresponding opening is provided such that the pin of the securing means protrudes into this opening once the cutting member 68 has taken its correct position on the support surface 58.

Thus, for mounting the cutting member 68 on the carrier frame 26 via the first multi-purpose interface 54, the cutting member 68 is positioned on the support surface 58 in a slightly offset position such that the hooks of the cutting member 68 protrude through the corresponding openings 70 but do not engage the engagement bolts 72.

Subsequently, the cutting member 68 is shifted in a direction transverse to the processing direction P while staying in contact with the support surface 58. In doing so, the hooks engage the corresponding engagement bolts 72. Once the desired position of the cutting member 68 is reached, the securing pin of the securing means moves into the corresponding opening on the cutting member 68.

Then the cutting member 68 is secured in its desired operational position.

As has been mentioned before in connection with the blanking assembly 24, also the correct position of the cutting member 68 may be detected by a sensor, e.g. a proximity sensor.

In its configuration as a full-sheet tool the sheet material processing tool 14 also comprises a sheet support member 74 for supporting and/or guiding a sheet to be processed.

The sheet support member 74 is connected to the carrier frame 26 via the second multi-purpose interface 56.

Thus, the sheet support member 74 may be considered to be a second tool element.

The sheet support member 74 abuts against a support surface 76 of the second multi-purpose interface 56 (see especially FIG. 5).

Moreover, as the first multi-purpose interface 54, also the second multi-purpose interface 56 comprises a plurality of openings 78 which are arranged in the support surface 76.

Behind each of these openings 78 an engagement bolt 80 is provided.

In the example shown the engagement bolts 80 substantially extend along the processing direction P (cf. FIG. 5).

On a lower side of the sheet support member 74 hooks (not shown) are provided which are configured to extend through a respective one of the openings 78 and engage the corresponding engagement bolt 80.

The hooks may be spring biased such that the sheet support member 74 is securely held on the support surface 76 if the hooks engage the corresponding engagement bolts 80.

As has been already explained in connection with the cutting member 68, the surfaces of the hooks of the sheet support member 74 engaging the engagement bolts 80 may be sloped in order to achieve the same effect.

In the example shown two openings 78 with respective engagement bolts 80 are provided. Accordingly, the sheet support member 74 comprises two hooks.

Furthermore, the second multi-purpose interface 56 comprises a securing means in the form of a pin (not shown) being supported on the rear wall 36 such that it protrudes from the support surface 76 in a spring biased manner.

On the sheet support member 74 a corresponding opening is provided such that the pin of the securing means protrudes into this opening once the sheet support member 74 has taken its correct position on the support surface 76.

Thus, for mounting the sheet support member 74 on the carrier frame 26 via the second multi-purpose interface 56, the sheet support member 74 is positioned on the support surface 76 in a slightly offset position such that the hooks of the sheet support member 74 protrude through the corresponding openings 78 but do not engage the engagement bolts 80.

Subsequently, the sheet support member 74 is shifted in a direction transverse to the processing direction P while staying in contact with the support surface 76. In doing so, the hooks engage the corresponding engagement bolts 80.

Once the desired position of the sheet support member 74 is reached, the securing pin of the securing means moves into the corresponding opening on the sheet support member 74.

Then the sheet support member 74 is secured in its desired operational position.

As before, also the correct position of the sheet support member 74 may be detected by a sensor, e.g. a proximity sensor.

FIG. 11 shows the sheet material processing tool 14 which is configured as a full-sheet tool.

In contrast to the representations of FIGS. 8 to 10, the side walls 38, 40 and the rear wall 36 have been moved such that the sheet material processing tool 14 now is adapted to sheets having a smaller size.

It is additionally noted that in FIGS. 8 and 11 a drive unit 82 is represented which is configured for moving the rear wall 36 in a motorized manner.

1. A sheet material processing tool (14), especially cardboard or paper processing tool, comprising:
a carrier frame, including:
a front frame member extending substantially perpendicular to a processing direction for a sheet material to be processed,
a rear frame member extending substantially parallel to the front frame member and substantially perpendicular to the processing direction,
a first lateral frame member connecting corresponding first ends of the front frame member and the rear frame member, and
a second lateral frame member connecting corresponding second ends of the front frame member and the rear frame member,
wherein the second ends and the first ends are arranged opposite each other, and
a first multi-purpose interface for selectively connecting a first tool element for processing the sheet material to the carrier frame.

2. The sheet material processing tool according to claim 1, further comprising:
a rear wall extending substantially parallel to the rear frame member,
a first side wall extending substantially parallel to the first lateral frame member, and
a second side wall extending substantially parallel to the second lateral frame member,
wherein the front frame member, the rear wall, the first side wall, and the second side wall delimit a duct through which the sheet material or portions of the sheet material may pass.

3. The sheet material processing tool according to claim 2, wherein at least one of the rear wall, the first side wall, and the second side wall are movably supported within the carrier frame such that a size of the duct is adjustable.

4. The sheet material processing tool according to claim 3, wherein at least one of the rear wall, the first side wall, and the second side wall is coupled to a respective drive unit such that the at least one of the rear wall, the first side wall, and the second side wall is adjustable within the carrier frame in a motorized manner.

5. The sheet material processing tool according to claim 2, further comprising:
a flexible cover attached to the rear wall and/or the rear frame member such that a spacing between the rear wall and the rear frame member is covered.

6. The sheet material processing tool according to claim 2, further comprising:
a second multi-purpose interface for selectively connecting a second tool element for processing the sheet material to the carrier frame.

7. The sheet material processing tool according to claim 6, wherein the second multi-purpose interface is arranged on the rear wall.

8. The sheet material processing tool according to claim 1, wherein the first multi-purpose interface is provided on the front frame member.

9. The sheet material processing tool according to claim 1,
wherein the first tool element is a cutting member for cutting a sheet to be processed, and
wherein the first tool element is connected to the carrier frame via the first multi-purpose interface.

10. The sheet material processing tool according to claim 6,
wherein the second tool element is a sheet support member for supporting and/or guiding a sheet to be processed, and
wherein the second tool element is connected to the carrier frame via the second multi-purpose interface.

11. The sheet material processing tool according to claim 6,
wherein the first tool element and the second tool element are a blanking assembly,
wherein the blanking assembly is connected to the carrier frame via the first multi-purpose interface and the second multi-purpose interface.

12. The sheet material processing tool according to claim 11, wherein the blanking assembly comprises at least one separation bar separating a processing plane of the blanking assembly in at least two sections, each corresponding to a blank to be removed from a sheet to be processed.

13. A sheet material processing station comprising:
a support structure, connected to the sheet material processing tool according to claim 1.

14. The sheet material processing station according to claim 13, wherein the sheet material processing tool is supported in the support structure via at least one linear bearing means such that the sheet material processing tool may selectively be arranged in:
an operational position, in which the sheet material processing tool is configured for at least contributing to the processing of sheet material, or
in an extended position, in which the sheet material processing tool sticks out from the support structure.

15. A sheet material processing machine, especially a sheet material cutting machine, comprising:
the sheet material processing station according to claim 13.
